(19) United States
(12) Patent Application Publication
(10) Pub. No.: US 2024/0144329 A1
(43) Pub. Date: May 2, 2024

(54) METHOD FOR OBSERVING AND COMPUTING DATA ACCESS COST IN MULTI-CLOUD ENVIRONMENT

(71) Applicant: Cisco Technology, Inc., San Jose, CA (US)

(72) Inventors: Hemal V. Surti, Cary, NC (US); Chockalingam Ramiah, Cary, NC (US); Rajiv Asati, Morrisville, NC (US)

(21) Appl. No.: 17/975,795

(22) Filed: Oct. 28, 2022

(51) Int. Cl. G06Q 30/0283; G06F 11/34

(52) U.S. Cl. CPC G06Q 30/0283; G06F 11/3495

(57) ABSTRACT

A method performed by a controller configured to communicate with one or more cloud platforms that are configured to host application components, which are configured to implement user services over a network, the method comprising: generating an application dependency mapping of the application components; collecting traffic flow data to identify data transfers between the application components; defining an application boundary around particular application components of the application components in the application dependency mapping; overlaying the application dependency mapping, the traffic flow data, and the application boundary, to identify particular data transfers between the particular application components; computing a network cost based on individual costs of the particular data transfers; and adding, to the network cost, compute and storage costs for the particular application components, to produce a total cost of using the particular application components.

### TECHNICAL FIELD

The present disclosure relates generally to computing a cost of applications distributed across multiple clouds.

### BACKGROUND

Moderate to large enterprises have hundreds of applications hosted on cloud platforms of different cloud providers (e.g., on Amazon, Google, and VMware clouds) spanning many regions around the world. The cost of operating these multi-cloud applications is evaluated against business outcomes and user experience requirements; however, most cloud-based cost optimization platforms focus on infrastructure and platform cost (e.g., compute and storage costs in a given cloud). The data access cost is not considered or mostly ignored. Current cost optimization platforms do not provide a way to correlate infrastructure and platform cost information, or mostly ignored data access cost, accurately at a more granular per application level. Such cost computations for multi-cloud applications are complicated by the distributed and multi-tiered aspects of the applications. For example, most cloud providers only break down charges for data egress, whereas data transfer costs over cloud-provider backbones differ from over-the-Internet charges through Internet gateways. Moreover, it is difficult to characterize and allocate the data transfer costs per application transaction, especially in complex, multi-cloud deployments. Data access cost depends on the type of transport, location of data, frequency of access, and storage utilization, including disaster recovery (DR), backup, and restore operations.

### BRIEF DESCRIPTION OF THE DRAWINGS

FIG. 1 is a block diagram of a multi-cloud environment in which a controller computes costs of employing application components (i.e., “application component costs”) across multiple clouds to implement business transactions and provide services to users, according to an example embodiment.

FIG. 2 is an illustration of high-level functions performed by the controller to compute the application component costs, overlayed on cloud resources for multiple clouds of the multi-cloud environment, according to an example embodiment.

FIG. 3 is an illustration of additional high-level functions performed by the controller to compute the application component costs, expanding on the functions of FIG. 2, according to an example embodiment.

FIG. 4 is a flowchart of a method of computing the application component costs in the multi-cloud environment, according to an example embodiment.

FIG. 5 is an illustration of the method of FIG. 4 as performed for a multi-cloud application deployment in the multi-cloud environment, according to an example embodiment.

FIG. 6 illustrates a hardware block diagram of a computing device that may perform functions associated with operations discussed herein in connection with the techniques depicted in FIGS. 1-5, according to an example embodiment.

### DETAILED DESCRIPTION

### Overview

In an embodiment, a method is performed by a controller configured to communicate with one or more cloud platforms that are configured to host application components, which are configured to implement user services over a network. The method comprises: generating an application dependency mapping of the application components; collecting traffic flow data to identify data transfers between the application components; defining an application boundary around particular application components of the application components in the application dependency mapping; overlaying the application dependency mapping, the traffic flow data, and the application boundary, to identify particular data transfers between the particular application components; computing a network cost based on individual costs of the particular data transfers; and adding, to the network cost, compute and storage costs for the particular application components, to produce a total cost of using the particular application components.

### Example Embodiments

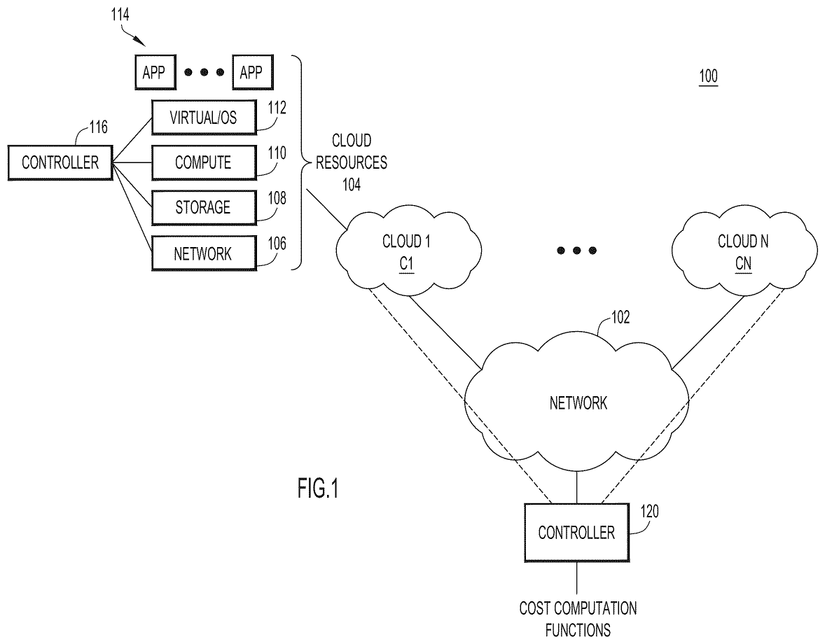

Referring to FIG. 1, there is a block diagram of an example multi-cloud environment 100 in which embodiments presented herein may be implemented. Multi-cloud environment 100 includes multiple clouds C1-CN that communicate with each other, and are accessible to users, over a network 102 connected to the clouds. The “clouds” may also be referred to as “cloud platforms” and “cloud provider platforms.” The clouds may be “public” clouds that are publicly accessible. Network 102 may include one or more local area networks (LANs) and one or more wide area networks (WANs), such as the Internet. Each cloud Ci respectively resides in multiple geographically distributed data centers, for example. Each cloud Ci respectively includes a collection of cloud resources 104. For convenience, only one instance of cloud resources 104 is shown in FIG. 1. Cloud resources 104 include components for network 106 (e.g., routers, switches, communication links, and the like), storage 108, compute 110, and a virtualization and operating system layer 112. Cloud resources 104 collectively support use of multiple application components 114 to implement services for users. Each cloud Ci includes a cloud controller 116 to control the aforementioned cloud components and provide an administrator with access to the cloud.

An application component is an executable computer program. Multiple application components interact with each other to implement a cloud-based user service, for example. The application components that implement the cloud-based user service may be hosted on/across multiple ones of clouds C1-CN. The multiple application components that implement the cloud-based user service collectively form a high-level application. In some embodiments, each application component may comprise multiple subordinate application components. In one example, application components include microservices.

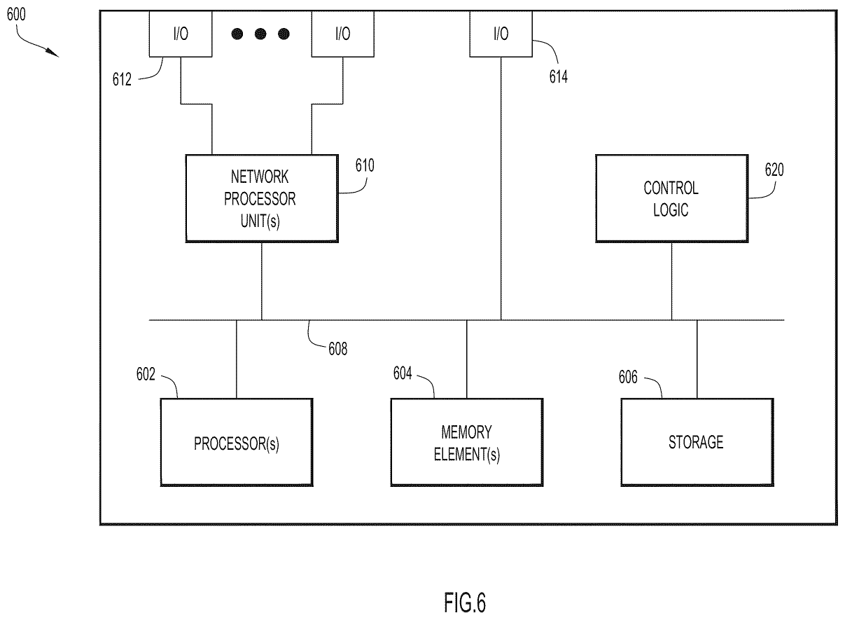

Multi-cloud environment 100 also includes a controller 120 connected to clouds C1-CN either directly or through network 102. In accordance with embodiments presented herein, controller 120 collects resource utilization information from clouds C1-CN at a detailed or granular level, and computes granular-level costs associated with using application components 114 within and across the clouds (i.e., computes application component costs) based on the collected resource utilization information, as described below. To this end, controller 120 implements a collection of functions that perform cost computations. Controller 120 may be implemented in software, hardware, or a combination of both hardware and software, as described in connection with FIG. 6.

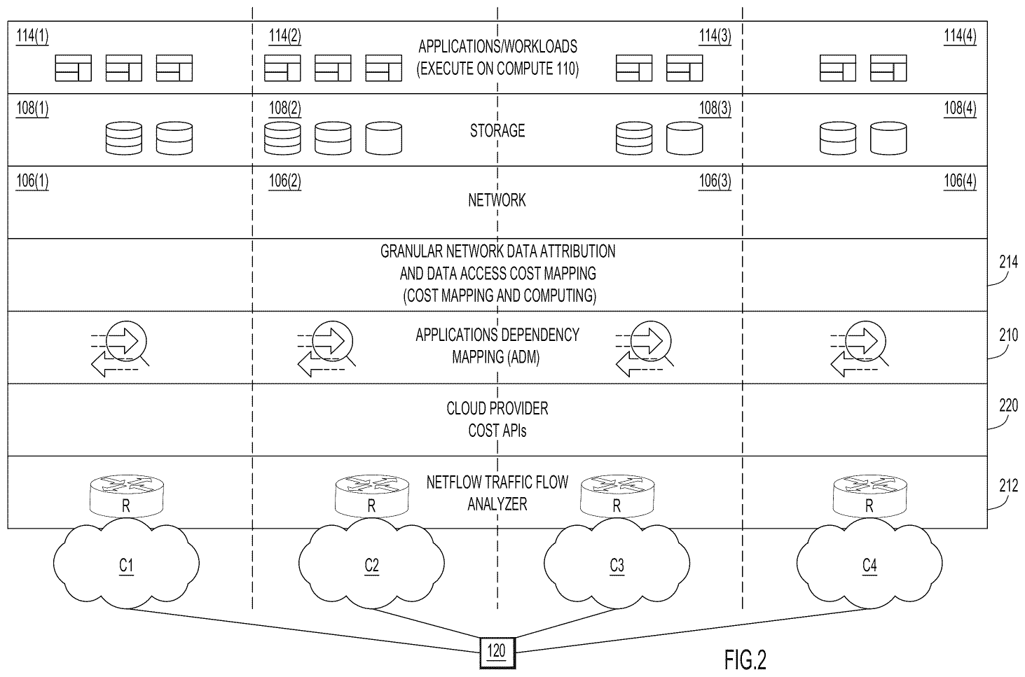

FIG. 2 is an illustration of example high-level functions performed by controller 120 to compute the costs of application components, overlayed on or across the cloud resources of multiple clouds C1-C4. Clouds C1-C4 are represented as columns of cloud resources in FIG. 2. In the example of FIG. 2, clouds C1, C2, C3, and C4 include the Amazon Web Service (AWS), the Google Cloud Platform (GCP), OpenStack, and Azure by Microsoft, although other cloud platforms are possible. Resources for clouds C1, C2, C3, and C4 respectively include (network, storage) (106(1), 108(1)), (106(2), 108(2)), (106(3), 108(3)) and (106(4), 108(4)). Clouds C1, C2, C3, and C4 support respective sets or groups of application components 114(1), 114(2), 114(3), and 114(4) that execute on their respective compute layer.

Conventional multi-cloud cost computation focuses on infrastructure costs, such as compute and data storage costs, and on over-simplified cloud service costs. This limited view is due to the fact that attributing accurate granular-level application component costs in shared multi-cloud environments is extremely challenging. For example, many cost optimization efforts are limited to removing zombie assets or right-sizing but do not have application cost profiling that can be used for application design decisions. To determine more accurate granular-level application component costs, controller 120 employs (1) dynamic resource discovery through application dependency mapping (ADM) (referred to simply as “ADM”) 210, (2) a network traffic flow analyzer 212 to perform network traffic flow analysis, and (3) cost mapping and computing 214, which performs granular-level network data attribution and data access cost mapping. The foregoing functions collect detailed information about the application components within each cloud and across the multiple clouds through cloud-based portals R (e.g., routers and the like), to provide correspondingly detailed cost analysis. Cost mapping and computing 214 may be incorporated in controller 120 or implemented separately from the controller.

For example, ADM 210 generates accurate application dependency mapping of all application components within and spanning (i.e., across) clouds C1-C4, and network traffic flow analyzer 212 accurately identifies all network traffic flows (i.e., “data transfers” or “data transactions”) between the application components within and spanning the clouds. Cost mapping and computing 214 correlates the results from ADM 210 and network traffic flow analyzer 212, and maps the correlation result to real-time cost data provided by cloud provider cost application programming interfaces (APIs) 220 to compute detailed costs, as described below.

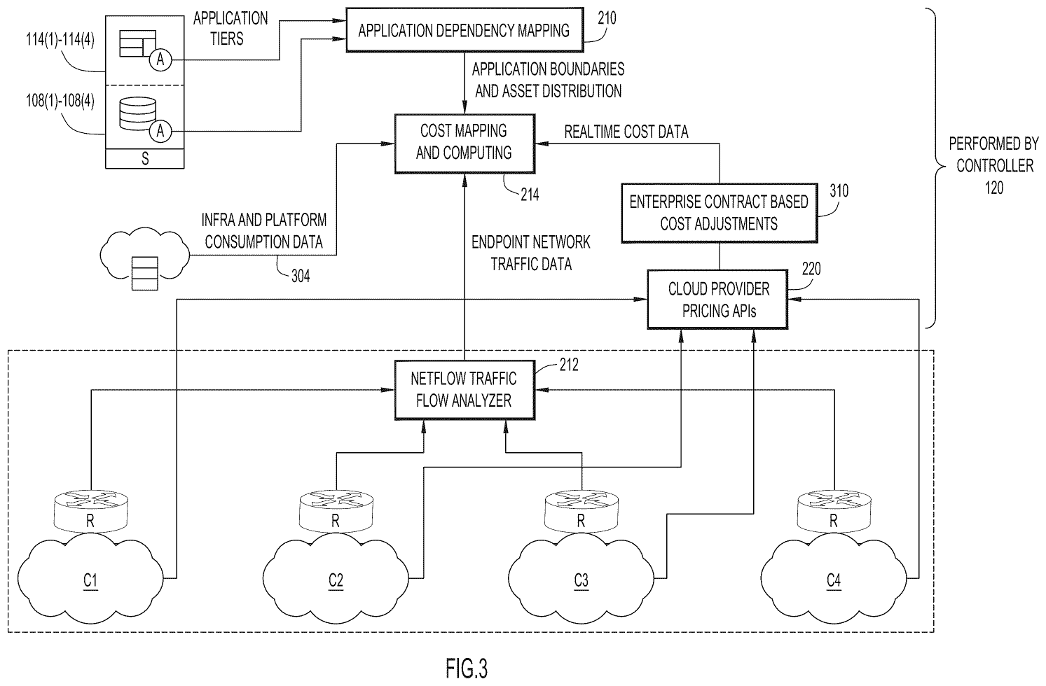

FIG. 3 is an illustration of additional example high-level functions performed by controller 120 to compute the applications, expanding on the functions shown in FIG. 2. In the example of FIG. 3, cloud servers S that host applications components 114(1)-114(4) and storage 108(1)-108(4) also host instrumentation agents A. Instrumentation agents A collect (i) information from/about all of application components 114(1)-114(4) for application dependency maps generated by ADM 210, and (ii) traffic flow data from network 106(1)-106(4) identifying and quantifying all traffic flows (i.e., all data transfers) between all of the application components and storage 108(1)-108(4) on behalf of network traffic flow analyzer 212. ADM 210 provides, to cost mapping and computing 214, the application dependency maps along with a definition of an application boundary around or delineating particular application components (i.e., a group or subset of application components) that are of interest among all of application components 114(1)-114(4). The application boundary carves out (i.e., separates) the particular application components from all of the other application components in the application dependency maps. Network traffic flow analyzer 212 provides the traffic flow data to cost mapping and computing 214. As described below, cost mapping and computing 214 performs multi-cloud asset distribution, application categorization, traffic flow (i.e., data transfer) mapping, and cost aggregation using the information from ADM 210 and network traffic flow analyzer 212.

More specifically, cost mapping and computing 214 overlays the application boundary on the traffic flow data identifying all of the data transfers, to produce/identify particular data transfers that occur between the particular application components and their associated storage (i.e., the storage accessed by the particular application components). Cost mapping and computing 214 also receives infrastructure/cloud consumption data 304 (i.e., the amount of compute and storage used by the particular application components and their associated storage), and pricing or cost information accessed through cloud provider cost APIs 220. Based on the cost information, cost mapping and computing 214 computes costs of individual ones of the particular data transfers and totals the costs of the individual ones of the particular data transfers into a total data transfer cost. Cost mapping and computing 214 further computes an infrastructure/cloud consumption cost based on the infrastructure/cloud consumption data and adds the infrastructure/cloud consumption cost to the total data transfer cost, to produce a total cost of using the particular application components. Additionally, cost mapping and computing 214 may adjust the total cost of using the particular application components based on enterprise contract-based cost adjustments 310.

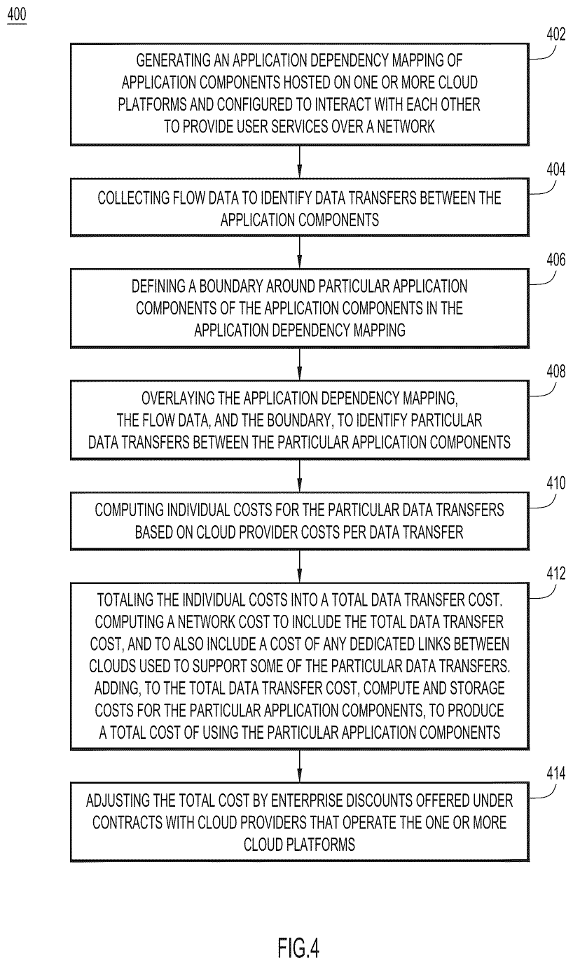

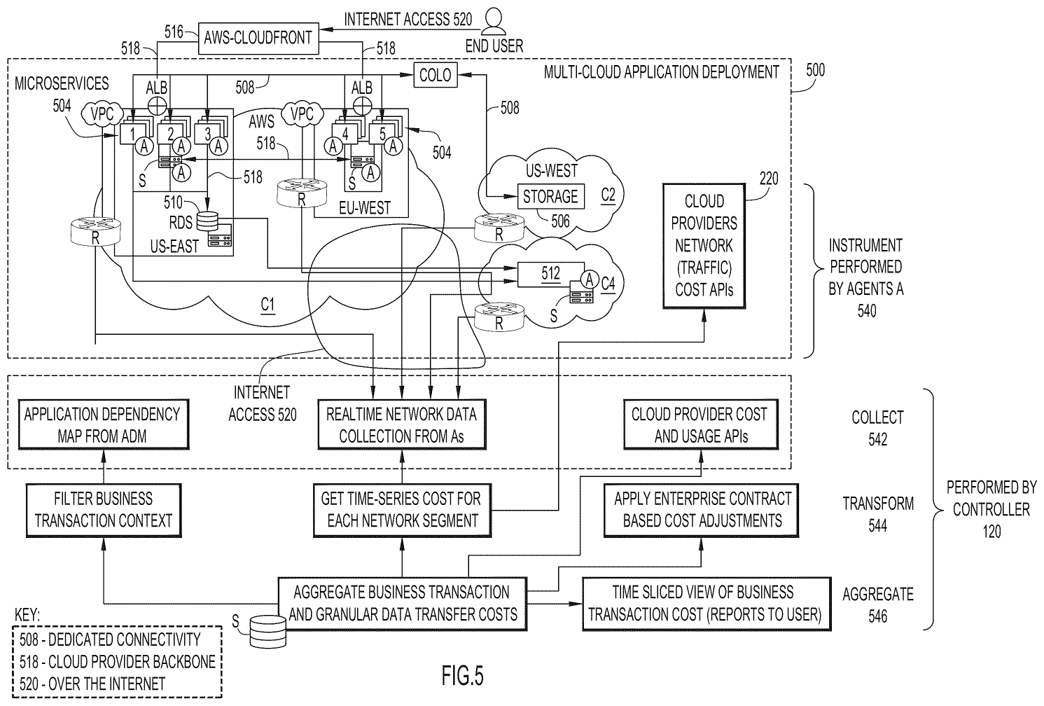

FIG. 4 is a flowchart of an example method 400 of computing costs of application components that are hosted on one or more clouds (e.g., one or more of clouds C1-C4) and are configured to communicate with each other to provide services to a user (i.e., user services) over a network. That is, the application components, when executed on their respective clouds, implement the services for the user. Method 400 may be performed primarily by controller 120, with the assistance of instrumentation agents A that collect cost-related information from the one or more clouds on behalf of the controller. Method 400 comprises operations described above in connection with FIGS. 1-3, and below in connection with FIG. 5. A detailed example of method 400 will be described below in connection with FIG. 5.

At 402, controller 120 performs application dependency mapping to generate end-to-end application dependency maps for all of the application components hosted across clouds C1-C4. Controller 120 may employ any known or hereafter developed ADM tools to perform the application dependency mapping.

At 404, controller 120 collects traffic flow data identifying all of the network traffic flows (i.e., data transfers) between all of the application components. The endpoints of each data transfer may be application components, storage, or an application component and storage, for example. Controller 120 may employ any known or hereafter developed network analyzer tool to perform the collection, such as NetFlow, which builds data transaction interaction diagrams across endpoints (e.g., application components and storage).

At 406, controller 120 receives a definition of an application boundary around particular application components among all of the applications components. The definition of the application boundary may group together the particular application components that implement (i.e., that are used to support) a particular business transaction or high-level application for a user or an application workload. In other words, operation 406 may group the particular application components by business transaction or workload. The user may enter/define the application boundary (also referred to simply as a “boundary”) using an ADM tool that tags the particular application component within the application boundary, for example

At 408, controller 120 overlays (i) the application dependency maps, (ii) the data transfers as represented in the traffic flow data identifying the data transfers, and (iii) the application boundary, to identify or carve out particular data transfers between the particular application components (and their associated storage).

At 410, controller 120 computes individual costs for the particular data transfers based on cloud provider costs per data transfer, as identified using cloud provider cost APIs, based on the type of connectivity (i.e., connectivity type) used by each data transfer (e.g., dedicated link, Backbone, Internet, VPN, or other connectivity type), an amount of data transferred in each data transfer, a direction of each data transfer, and types of endpoints.

At 412, controller 120 totals the individual costs for the particular data transfers to produce a total data transfer cost for the particular application components. Controller 120 computes a network cost to include the total data transfer cost, and to include a cost of any dedicated connection links between the clouds (described below) and over which at least some of the particular data transfers occur. Controller 120 adds, to the network cost, compute and storage costs (e.g., infrastructure/cloud consumption costs) for the particular application components, to produce a total cost of using the particular application components. Operation 412 aggregates real-time costs of the particular data transfers with long term costs of the connectivity types that support the particular data transfers for a given time slice.

When the particular application components are distributed across/hosted on multiple clouds, the particular data transfers may include both intra-cloud data transfers within each cloud, and inter-cloud data transfers between the clouds, in which case operation 412 computes first (i.e., intra-cloud) individual costs for the intra-cloud data transfers and second (i.e., inter-cloud) individual costs for the inter-cloud data transfers, and totals the first individual costs with the second individual costs.

At 414, controller 120 adjusts the total cost from 412 by enterprise discounts offered under contracts with cloud providers that operate the one or more clouds, and reports the adjusted cost. Additionally, an operator may employ the reported costs and other utilities of controller 120 to make design optimizations based on the cost, performance, and availability requirements.

FIG. 5 is an illustration of method 400 as performed for an example multi-cloud application deployment 500 in multi-cloud environment 100. Multi-cloud application deployment 500 includes clouds C1 (e.g., AWS), C2 (e.g., GCP), and C4 (e.g., Azure). AWS hosts application components in the form of 5 microservices 504 (denoted 1, 2, 3, 4, and 5) on respective servers S deployed on 2 elastic compute cloud (EC2) instances deployed across two AWS regions US-EAST and EU-WEST. Microservices 504 ingest transactional data accessed from cloud storage 506 hosted on GCP US-WEST through dedicated link 508, which is provided by a colocation (“Colo”) service provider. Microservices 504 store the transactional data to PostgreSQL relational database service (RDS) 510 on AWS US-EAST. The stored transactional data is used by embedded PowerBI reports servers 512 running in the Central US region of Azure. An end user may access services supported by microservices 504 through an application user portal 516. Application user portal 516 may be accelerated by an AWS Cloud Front Service, for example. Also, application user portal 516 may leverage application load balancers (ALBs) to communicate to business logic functionality provided by microservices 504, for example.

Network traffic (i.e., data transfers) between the various resources/components of multi-cloud application deployment 500 may occur over different connectivity types. For example, the different connectivity types includes a cloud provider backbone 518, dedicated connectivity (e.g., dedicated link 508), and the Internet 520. Cloud provider backbone 518 is an intra-cloud network that does not extend outside the cloud and that supports data transfers between (i) application user portal 516 and microservices 504 through the application load balancers, and (ii) the microservices and storage (e.g., RDS 510). Data transfers between the different clouds occur over the Internet or over dedicated link 508. A significance of identifying the different connectivity types is that data transfers that occur over the different connectivity types have different costs specifically depending on the connectivity types.

Table 1 below summarizes some of the assets or components used in the multi-cloud application deployment 500.

TABLE 1

| | Location | Cloud |
|---|---|---|
| Services/Resources | (Region) | Provider |
| 5 Microservices 504 | US-EAST, | AWS (C1) |
| | EU-WEST | |
| Cloud Storage (data) 506 | US-WEST | GCP (C2) |
| Transactional data (from | US-EAST (RDS - | AWS (C1) |
| 510) | PostgreSQL) | |
| Reports (from servers 512) | Central US | Azure (C4) |

Multi-cloud application deployment 500 represents a simplified application deployment scenario. In contrast, in mid-to-large enterprises, hundreds to thousands of active application components share compute, storage, and network resources across multiple clouds. Most cloud providers can derive at least some high-level infrastructure costs (e.g., compute and storage costs) for application components; however, the same is not true for shared network/data transfer costs.

Embodiments presented herein determine a total cost at a granular level that includes individual inter- and intra-cloud data transfer costs. For the example of FIG. 5, the embodiments compute total cost based on derivation of the following costs:
a. Cost of EC2 instances.
b. Cost of cloud storage.
c. Cost of RDS.
d. Costs of PowerBI servers.
e. Data egress cost from cloud storage in GCP to EC2 in AWS.
f. Data egress costs from PostgreSQL RDS in AWS to embedded PowerBI servers in Azure.

The embodiments derive the following further costs:
a. Cost of operating and scaling individual microservices.
b. Overall application component cost when more than one application component executes across the same account/project/subscription boundary.
c. Per-user transaction costs per application component.
d. Forecasting scaling costs for individual microservices.
e. Cost of data access/transfer when multiple application costs are deployed in the various cloud regions.
f. Consumption and usage information about shared microservices.

The embodiments derive granular cost visibility across all of the cloud resource components (microservices, storage, and data transfer) by accurately attributing the costs to individual business transactions conducted by a user. Compute costs and storage costs may be readily obtained. For example, compute costs on AWS are derived by the target instances on which the microservices are running. When multiple microservices are running on each instance, container tagging may be used to derive individual costs. Such costs are visible even in a multi-tenant deployment. Also, storage costs on GCP are based on the size of the storage buckets that are used. Storage size and type of storage determine the cost of storage and can be derived through billing information or by calling cost APIs of GCP. These are also possible to obtain in a multi-tenant scenario.

On the other hand, network consumption (i.e., data transfer) costs in the above shared environment is extremely difficult to derive as data transfer costs are dependent on the following different aspects or factors:
a. Connectivity type (dedicated, cloud provider backbone, Internet, virtual private network (VPN), and so on).
b. Size of data transferred.
c. Bandwidth requirements.
d. Direction of the data transfer (outbound for network cost, bidirectional for AWS services like EC2, RDS, etc.). Cloud providers may only charge for data egress, and the charges may depend on what type of connectivity is used for egress.

The following operations (from method 400) may be used to derive the network consumption (i.e., data transfer) costs in the example of FIG. 5.

At 402, conduct application dependency mapping using an ADM tool. Performing ADM on AWS produces application dependency mapping (i.e., maps) of (i) EC2 instances running the elastic container service (ECS) and RDS (PostgreSQL) in AWS, (ii) an external cloud storage endpoint in GCP, and (iii) an external endpoint of virtual machines running PowerBI in Azure. In a multi-tenant environment, there will be many more components of other applications in the application dependency mapping, which are not shown in FIG. 5.

At 404, use network flow traffic analysis capabilities provided by the cloud providers and/or third party NetFlow analyzers to collect traffic flow data identifying data transfers between the endpoints within AWS and data egressing from AWS to GCP and Azure. The traffic flow data identifies endpoints (e.g., application component and/or storage), connectivity type (e.g., cloud provider backbone, dedicated, or Internet/WAN), data size (e.g., number of bytes), and direction (e.g., egress or ingress from the perspective of the cloud) for each data transfer. In other words, each data transfer is uniquely identified (e.g., by a record identifier) and is associated with or linked to metadata that lists endpoints, connectively type, data size, and direction.

At 406, use the ADM tool to define an application boundary based on a scope of a business transaction context that encompasses particular application components. The ADM tool may use labels, tags, or metadata to define these contexts. For example, a high-level application or business transaction may offer 3 core business functionalities, including user authentication, browsing of a product catalog, and purchase of a product from the catalog, respectively mapped to corresponding ones of 3 microservices of microservices 504. The remaining 2 microservices may provide internal services for data access and logging. Thus, the application boundary for the high level application/business transaction may encompass the 3 microservices that provide user authentication, browsing, and purchase functionality.

At 408, overlay the data collected in 402, 404, and 406 to identify the particular data transfers between the particular application components within/for the business transaction. As mentioned above, each particular data transfer identified by the overlay is associated with metadata that lists endpoints, connectively type, data size, and direction. In an example, if it is desired to determine the cost of a user in Germany browsing a catalog that may include viewing product videos, operations 402-406 capture data for computing costs for that business transaction, and operation 408 aggregates and isolates the data collected across the previous operations.

At 410, call cloud platform cost APIs of AWS and GCP to identify and compute individual costs for individual ones of the particular data transfers based on the connectively type, data size, and direction for each data transfer. For example, the cost/price APIs indicate a cloud provider backbone data transfer cost (or charge), a dedicated link (i.e., connectivity) transfer cost (which may be a fixed monthly subscription cost independent of per data transfer cost, such as cost per byte), a data transfer ingress or egress cost, a cost per byte, and so on, to be applied against the corresponding characteristics of each data transfer.

Continuing with the example in which the user from Germany browses the catalogue, the user accesses the application (to shop) through AWS CloudFront EU-WEST based on application load balancing policies. Traffic (i.e., data transfers) for a request from the user to AWS EU-WEST initially traverses the Internet. Once the request reaches AWS, the request traverses the AWS inter-availability zone (intra AZ) and intra-regions backbone (more generally, the cloud provider backbone). For any modern application that is not monolithic, there is a sizable traffic load traversing the cloud provider backbone (e.g., Global, intra-AZ, inter-AZ, inter-region, and so on) and the user may be charged different cloud provider backbone rates. Application components typically use various cloud provider services that send traffic over the cloud provider backbone, and that traffic is charged separately from consumption of the service itself.

Operation 410 calls AWS and GCP cost APIs for various data transfers listed below in Table 2, in which GB represents Gigabytes and TB represents Terabytes.

TABLE 2

| | Connectivity | |
|---|---|---|
| Cost Component | Type | Charges |
| Load balancer to EC2 instances in EU- | AWS Intra AZ | Per GB |
| WEST virtual private cloud (VPC) | Backbone | |
| EC2 in EU-WEST VPC to PostgreSQL | AWS Intra Region | Per GB |
| RDS in US-EAST region for user | Backbone | |
| preferences data | | |
| EC2 in EU-WEST VPC to EC2 in US- | AWS Intra Region | Per GB |
| EAST VPC for Authentication | Backbone | |
| Passing product profile information to | AWS Dedicated | Per GB |
| GCP for product data download | connectivity to Colo | |
| Static data traversing from the EU- | AWS Global | Tiered |
| WEST load balancer to CloudFront | Backbone | cost in |
| endpoint | | TB |
| Data egress for each product informa- | GCP Dedicated | Per GB |
| tion call from AWS including videos | connectivity to Colo | |
| transfer | | |

At 412, aggregate/compute the network traffic costs focusing on the scope of business transaction (browsing the product catalog in the example) based on information gathered at operation 410. To do this, operation 412 totals the individual (granular) costs of the particular data transfers into an accurate total data transfer cost. Additionally, when at least some of the particular data transfers occur over a dedicated link between different cloud platforms of different cloud providers, operation 412 adds, to the total data transfer cost, a cost of the dedicated connectivity, to produce a network cost. The cost of dedicated connectivity includes the appropriated cost of dedicated and secure network infrastructure (i.e., dedicated connectivity or link). In the example of FIG. 5, the dedicated connectivity includes dedicated infrastructure in place between AWS and GCP through colocation facility Colo, e.g., within the US.

Operation 412 then adds, to the network cost, the compute and storage costs for the business transactions, to produce a total cost of using the particular application components to implement the business transaction, i.e., a total business transaction cost. The compute and storage costs can be collected through billing APIs provided by the cloud providers (e.g., AWS and GCP). Operation 412 stores the aforementioned computed costs in a timeseries database on a regular interval which is configurable from seconds to minutes depending on the application profile, for example.

At 414, before storing the total business transaction cost and reporting the same to a user, factor in any enterprise discounts offered based on contracts with the cloud providers (AWS and GCP in the example). In operation 414, the total business transaction cost from operation 412 may be adjusted (e.g., increased or decreased) based on the aforementioned factor, to produce an adjusted total business transaction cost, which is stored and reported.

The comprehensive cost information derived in the embodiments presented herein allows business owners to make decisions such as moving product information storage to different AWS or GCP regions, replicating the product information storage across multiple regions, and/or change the storage type, to reduce data transfer costs.

The operations described above in connection with FIG. 5 roughly fall into function layers including instrument 540, collect 542, transform 544, and aggregate 546. Instrumentation agents A perform instrument 540, while controller 120 primarily performs collect 542, transform 544, and aggregate 546. Collect 542 employs application dependency maps, real-time network data collection from instrumentation agents A, and cloud provider cost and usage APIs. Transform 544 filters data based on the application boundary or “business transaction context,” obtains timeseries cost for each network segment (and connectivity type), and applies enterprise contract-base cost adjustments. Aggregate 546 aggregates business transaction and granular data transfer costs and reports aggregated data/costs for time sliced views of the business transaction cost.

In summary, embodiments presented herein achieve granular cost computation for application components distributed across multiple clouds. The embodiments collect traffic flow data through network traffic flow aggregators, map the collected and aggregated traffic flow data to the application dependency maps, and build a cost aggregation based on the application dependency maps, the traffic flow data, and real-time cost inputs from cloud providers. The conventional approach to cost modeling has blind spots that make it difficult to measure accurate granular application component costs. The embodiments build cost visibility through accurately measuring network traffic between application components and attributing granular costs of application components and interaction between them.

The embodiments may perform operations to:
a. Build a cost optimization model for data access in a multi-cloud environment by eliminating blind spots.
b. Achieve granular allocation of network costs for an accurate workload-based cost model.
c. Identify accurate and granular costs for applications comprising application components.
d. Forecast: enable users to accurately and confidently conduct “what-if” scenarios to move data or workloads around different target cloud environments.
e. Generate cost-saving reports (called return on investments—ROI) based on various deployment models using the cost models for data access.
f. Leverage the ROI reports and expand savings further while doing scale-up or scale-down of the workload for scalability, high availability (HA), and customer experience (CX).
g. Predict OPEX forecast using data access cost models if the cloud provider makes any change in pricing structure per availability zone/region/geographical location.

Referring to FIG. 6, FIG. 6 illustrates a hardware block diagram of a computing device 600 that may perform functions associated with operations discussed herein in connection with the techniques depicted in FIGS. 1-6. In various embodiments, a computing device or apparatus, such as computing device 600 or any combination of computing devices 600, may be configured as any entity/entities as discussed for the techniques depicted in connection with FIGS. 1-6 in order to perform operations of the various techniques discussed herein. Computing device 600 may represent controller 120 described above.

In at least one embodiment, the computing device 600 may be any apparatus that may include one or more processor(s) 602, one or more memory element(s) 604, storage 606, a bus 608, one or more network processor unit(s) 610 interconnected with/coupled to one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to conduct operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RF ID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by a controller configured to communicate with one or more cloud platforms that are configured to host application components, which are configured to implement user services over a network, the method including: generating an application dependency mapping of the application components; collecting traffic flow data to identify data transfers between the application components; defining an application boundary around particular application components of the application components in the application dependency mapping; overlaying the application dependency mapping, the traffic flow data, and the application boundary, to identify particular data transfers between the particular application components; computing a network cost based on individual costs of the particular data transfers; and adding, to the network cost, compute and storage costs for the particular application components, to produce a total cost of using the particular application components.

In some aspects, the techniques described herein relate to a method, wherein computing the network cost includes: computing the individual costs for the particular data transfers based on cloud provider costs per data transfer, and totaling the individual costs into a total data transfer cost; and computing the network cost to include the total data transfer cost.

In some aspects, the techniques described herein relate to a method, wherein: collecting includes collecting the traffic flow data to identify application component endpoints, connectivity type, and data size for each data transfer; and computing the individual costs includes computing the individual costs for the particular data transfers based on the connectivity type and the data size for each particular data transfer.

In some aspects, the techniques described herein relate to a method, wherein: the connectivity type for first data transfers of the particular data transfers includes connectivity over a provider backbone; and computing the individual costs further includes computing first individual costs for the first data transfers based on a cloud provider backbone data transfer cost.

In some aspects, the techniques described herein relate to a method, wherein: at least some of the particular data transfers occur over a dedicated link between first and second cloud platforms of different cloud providers; and computing the network cost further includes computing the network cost to include a cost of the dedicated link.

In some aspects, the techniques described herein relate to a method, wherein the one or more cloud platforms include multiple cloud platforms and the particular application components are distributed across the multiple cloud platforms.

In some aspects, the techniques described herein relate to a method, wherein: the particular data transfers include intra-cloud data transfers within each cloud platform, and inter-cloud data transfers between each cloud platform; computing the individual costs includes computing first individual costs for the intra-cloud data transfers computing second individual costs for the inter-cloud data transfers; and totaling the individual costs includes totaling the first individual costs with the second individual costs.

In some aspects, the techniques described herein relate to a method, further including: adjusting the total cost by enterprise discounts offered under contracts with cloud providers that operate the one or more cloud platforms.

In some aspects, the techniques described herein relate to a method, wherein: defining includes defining the application boundary to group together the particular application components that implement a specific business transaction for a user; and the total cost of using the particular application components represents the total cost for the specific business transaction.

In some aspects, the techniques described herein relate to an apparatus including: a network input/output interface to communicate with a network; and a processor of a controller configured to communicate with one or more cloud platforms configured to host application components configured to implement user services over the network, the processor coupled to the network input/output interface and configured to perform: generating an application dependency mapping of the application components; collecting traffic flow data to identify data transfers between the application components; defining an application boundary around particular application components of the application components in the application dependency mapping; overlaying the application dependency mapping, the traffic flow data, and the application boundary, to identify particular data transfers between the particular application components; computing a network cost based on individual costs of the particular data transfers; and adding, to the network cost, compute and storage costs for the particular application components, to produce a total cost of using the particular application components.

In some aspects, the techniques described herein relate to an apparatus, wherein the processor is configured to perform computing the network cost by: computing the individual costs for the particular data transfers based on cloud provider costs per data transfer, and totaling the individual costs into a total data transfer cost; and computing the network cost to include the total data transfer cost.

In some aspects, the techniques described herein relate to an apparatus, wherein the processor is configured to perform: collecting by collecting the traffic flow data to identify application component endpoints, connectivity type, and data size for each data transfer; and computing the individual costs by computing the individual costs for the particular data transfers based on the connectivity type and the data size for each particular data transfer.

In some aspects, the techniques described herein relate to an apparatus, wherein: the connectivity type for first data transfers of the particular data transfers includes connectivity over a provider backbone; and the processor is configured to perform computing the individual costs further by computing first individual costs for the first data transfers based on a cloud provider backbone data transfer cost.

In some aspects, the techniques described herein relate to an apparatus, wherein: at least some of the particular data transfers occur over a dedicated link between first and second cloud platforms of different cloud providers; and the processor is configured to perform computing the network cost by computing the network cost to further include a cost of the dedicated link.

In some aspects, the techniques described herein relate to an apparatus, wherein the one or more cloud platforms include multiple cloud platforms and the particular application components are distributed across the multiple cloud platforms.

In some aspects, the techniques described herein relate to an apparatus, wherein: the particular data transfers include intra-cloud data transfers within each cloud platform, and inter-cloud data transfers between each cloud platform; the processor is configured to perform computing the individual costs by computing first individual costs for the intra-cloud data transfers computing second individual costs for the inter-cloud data transfers; and the processor is configured to perform totaling the individual costs by totaling the first individual costs with the second individual costs.

In some aspects, the techniques described herein relate to an apparatus, wherein the processor is further configured to perform: adjusting the total cost by enterprise discounts offered under contracts with cloud providers that operate the one or more cloud platforms.

In some aspects, the techniques described herein relate to a non-transitory computer readable medium encoded with instructions that, when executed by a processor of configured to communicate with one or more cloud platforms that are configured to host application components, which are configured to implement user services over a network, cause the processor to perform: generating an application dependency mapping of the application components; collecting traffic flow data to identify data transfers between the application components; defining an application boundary around particular application components of the application components in the application dependency mapping; overlaying the application dependency mapping, the traffic flow data, and the application boundary, to identify particular data transfers between the particular application components; computing a network cost based on individual costs of the particular data transfers; and adding, to the network cost, compute and storage costs for the particular application components, to produce a total cost of using the particular application components.

In some aspects, the techniques described herein relate to a non-transitory computer readable medium, wherein the instructions to cause the processor to perform computing the network cost include instructions to cause the processor to perform: computing the individual costs for the particular data transfers based on cloud provider costs per data transfer, and totaling the individual costs into a total data transfer cost; and computing the network cost to include the total data transfer cost.

In some aspects, the techniques described herein relate to a non-transitory computer readable medium, wherein: the instructions to cause the processor to perform collecting include instructions to cause the processor to perform collecting the traffic flow data to identify application component endpoints, connectivity type, and data size for each data transfer; and the instructions to cause the processor to perform computing the individual costs include instructions to cause the processor to perform computing the individual costs for the particular data transfers based on the connectivity type and the data size for each particular data transfer.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a controller configured to communicate with one or more cloud platforms that are configured to host application components, which are configured to implement user services over a network, the method comprising:
generating an application dependency mapping of the application components;
collecting traffic flow data to identify data transfers between the application components;
defining an application boundary around particular application components of the application components in the application dependency mapping;
overlaying the application dependency mapping, the traffic flow data, and the application boundary, to identify particular data transfers between the particular application components;
computing a network cost based on individual costs of the particular data transfers; and
adding, to the network cost, compute and storage costs for the particular application components, to produce a total cost of using the particular application components.

2. The method of claim 1, wherein computing the network cost includes:
computing the individual costs for the particular data transfers based on cloud provider costs per data transfer, and totaling the individual costs into a total data transfer cost; and
computing the network cost to include the total data transfer cost.

3. The method of claim 2, wherein:
collecting includes collecting the traffic flow data to identify application component endpoints, connectivity type, and data size for each data transfer; and
computing the individual costs includes computing the individual costs for the particular data transfers based on the connectivity type and the data size for each particular data transfer.

4. The method of claim 3, wherein:
the connectivity type for first data transfers of the particular data transfers includes connectivity over a provider backbone; and
computing the individual costs further includes computing first individual costs for the first data transfers based on a cloud provider backbone data transfer cost.

5. The method of claim 1, wherein:
at least some of the particular data transfers occur over a dedicated link between first and second cloud platforms of different cloud providers; and
computing the network cost further includes computing the network cost to include a cost of the dedicated link.

6. The method of claim 1, wherein the one or more cloud platforms include multiple cloud platforms and the particular application components are distributed across the multiple cloud platforms.

7. The method of claim 6, wherein:
the particular data transfers include intra-cloud data transfers within each cloud platform, and inter-cloud data transfers between each cloud platform;
computing the individual costs includes computing first individual costs for the intra-cloud data transfers computing second individual costs for the inter-cloud data transfers; and
totaling the individual costs includes totaling the first individual costs with the second individual costs.

8. The method of claim 1, further comprising:
adjusting the total cost by enterprise discounts offered under contracts with cloud providers that operate the one or more cloud platforms.

9. The method of claim 1, wherein:
defining includes defining the application boundary to group together the particular application components that implement a specific business transaction for a user; and
the total cost of using the particular application components represents the total cost for the specific business transaction.

10. An apparatus comprising:
a network input/output interface to communicate with a network; and
a processor of a controller configured to communicate with one or more cloud platforms configured to host application components configured to implement user services over the network, the processor coupled to the network input/output interface and configured to perform:
generating an application dependency mapping of the application components;
collecting traffic flow data to identify data transfers between the application components;
defining an application boundary around particular application components of the application components in the application dependency mapping;
overlaying the application dependency mapping, the traffic flow data, and the application boundary, to identify particular data transfers between the particular application components;
computing a network cost based on individual costs of the particular data transfers; and
adding, to the network cost, compute and storage costs for the particular application components, to produce a total cost of using the particular application components.

11. The apparatus of claim 10, wherein the processor is configured to perform computing the network cost by:
computing the individual costs for the particular data transfers based on cloud provider costs per data transfer, and totaling the individual costs into a total data transfer cost; and
computing the network cost to include the total data transfer cost.

12. The apparatus of claim 11, wherein the processor is configured to perform:
collecting by collecting the traffic flow data to identify application component endpoints, connectivity type, and data size for each data transfer; and
computing the individual costs by computing the individual costs for the particular data transfers based on the connectivity type and the data size for each particular data transfer.

13. The apparatus of claim 12, wherein:
the connectivity type for first data transfers of the particular data transfers includes connectivity over a provider backbone; and
the processor is configured to perform computing the individual costs further by computing first individual costs for the first data transfers based on a cloud provider backbone data transfer cost.

14. The apparatus of claim 10, wherein:
at least some of the particular data transfers occur over a dedicated link between first and second cloud platforms of different cloud providers; and
the processor is configured to perform computing the network cost by computing the network cost to further include a cost of the dedicated link.

15. The apparatus of claim 10, wherein the one or more cloud platforms include multiple cloud platforms and the particular application components are distributed across the multiple cloud platforms.

16. The apparatus of claim 15, wherein:
the particular data transfers include intra-cloud data transfers within each cloud platform, and inter-cloud data transfers between each cloud platform;
the processor is configured to perform computing the individual costs by computing first individual costs for the intra-cloud data transfers computing second individual costs for the inter-cloud data transfers; and
the processor is configured to perform totaling the individual costs by totaling the first individual costs with the second individual costs.

17. The apparatus of claim 10, wherein the processor is further configured to perform:
adjusting the total cost by enterprise discounts offered under contracts with cloud providers that operate the one or more cloud platforms.

18. A non-transitory computer readable medium encoded with instructions that, when executed by a processor of configured to communicate with one or more cloud platforms that are configured to host application components, which are configured to implement user services over a network, cause the processor to perform:
generating an application dependency mapping of the application components;
collecting traffic flow data to identify data transfers between the application components;
defining an application boundary around particular application components of the application components in the application dependency mapping;
overlaying the application dependency mapping, the traffic flow data, and the application boundary, to identify particular data transfers between the particular application components;
computing a network cost based on individual costs of the particular data transfers; and
adding, to the network cost, compute and storage costs for the particular application components, to produce a total cost of using the particular application components.

19. The non-transitory computer readable medium of claim 18, wherein the instructions to cause the processor to perform computing the network cost include instructions to cause the processor to perform:
computing the individual costs for the particular data transfers based on cloud provider costs per data transfer, and totaling the individual costs into a total data transfer cost; and
computing the network cost to include the total data transfer cost.

20. The non-transitory computer readable medium of claim 19, wherein:
the instructions to cause the processor to perform collecting include instructions to cause the processor to perform collecting the traffic flow data to identify application component endpoints, connectivity type, and data size for each data transfer; and
the instructions to cause the processor to perform computing the individual costs include instructions to cause the processor to perform computing the individual costs for the particular data transfers based on the connectivity type and the data size for each particular data transfer.
